(19) United States
(12) Patent Application Publication
(10) Pub. No.: US 2024/0293766 A1
(43) Pub. Date: Sep. 5, 2024

(54) FUNCTIONALIZED FILTERS

(71) Applicant: Sequoia Biolabs LLC, Newark, CA (US)

(72) Inventor: Pedram Sattari, Alamo, CA (US)

(73) Assignee: Sequoia Biolabs LLC, Newark, CA (US)

(21) Appl. No.: 18/645,691

(22) Filed: Apr. 25, 2024

Related U.S. Application Data
(63) Continuation of application No. 17/481,188, filed on Sep. 21, 2021, now abandoned.
(60) Provisional application No. 63/156,275, filed on Mar. 3, 2021.
(60) Provisional application No. 63/080,816, filed on Sep. 21, 2020.

(51) Int. Cl. B01D 39/20; C03C 25/66

(52) U.S. Cl. CPC B01D 39/2017; C03C 25/66; B01D 2239/0414; B01D 2239/10; B01D 2239/1216

(57) ABSTRACT

A functionalized glass fiber depth filter is provided, along with a method for making and using the filter. The glass fiber depth filter may be functionalized by an amino functional siloxane.

### CROSS-REFERENCE TO RELATED APPLICATIONS

This application claims priority from U.S. Provisional Patent Application No. 63/156,275, filed on Mar. 3, 2021, and U.S. Provisional Patent Application No. 63/080,816, filed on Sep. 21, 2020. Each of these applications is incorporated by reference herein in its entirety.

### BACKGROUND

Harvest or clarification of biological cell cultures, such as Chinese Hamster Ovary (CHO) cells and Human Embryonic Kidney (HEK) cells, continues to be an area of challenge. Culture density and viability variability lead to variability in particle/impurity profiles that challenge a static harvest filtration process. Further efforts by biologics manufacturers to maximize manufacturing suite utilization has led to a demand for single use, “plug and play” filtration solutions.

A typical harvest scheme aims at a three-stage approach: (1) initial clarification; (2) secondary clarification of finer impurities; and (3) a final 0.2 μm or 0.1 μm filter. While solutions for initial clarification of whole cells and large debris are clearly established via disk stack, continuous or single use centrifuge, tangential flow filtration, depth filtration, or even TFDF single-use harvest technology, the need for a secondary clarification filter that addresses both the technical and processing challenges of the industry is still unmet.

Current solutions for the secondary clarification step include: (1) lenticular filters composed of diatomaceous earth (DE) or a synthetic derivative glued via epoxy resin within a cellulose or synthetic fiber network; and (2) pleated depth filtration media composed of cellulose, glass fiber, or polymeric fiber. Each approach presents limitations.

First, lenticular filters provide high capacity, e.g., 100-300 L/m2, due to DE's relatively large surface area and absorptive properties. However, lenticular filters must be flushed with large amounts of water, buffer, or both to clear the endotoxins and metal contaminants present in the media. Further, lenticular filters lack sterile options.

Second, pleated depth filters can be gamma sterilized and do not require excessive flushing to decontaminate prior to use, making them user friendly. However, pleated depth filters lack adequate capacity and require large amounts of surface area, leading to increased costs and downtime due to filter clogging.

A need exists for a secondary clarification filter that has high capacity, is sterilizable, and does not require excessive flushing.

### SUMMARY

In one aspect, a glass fiber depth filter is provided, the glass fiber depth filter being functionalized by an amino functional siloxane. In one aspect, the amino functional siloxane comprises a quaternary amino functional siloxane corresponding to the general structure:

Cl⁻N⁺R1R2R3-(CH₂)n-Si(O⁻)₃

wherein
R1, R2, and R3 independently represent hydrogen, alkyl, cycloalkyl, aralkyl, or aryl; and
n is an integer of 1 to 15.

In another aspect, the amino functional siloxane comprises a di-amino functional siloxane corresponding to the general structure:

NR1R2-(CH₂)n-NR3-(CH₂)m-Si(O⁻)₃

wherein
R1, R2, and R3 independently represent hydrogen, alkyl, cycloalkyl, aralkyl, or aryl;
n is an integer of 1 to 15; and
m is an integer of 1 to 15.

In another aspect, a method is provided for preparing a glass fiber depth filter functionalized by an amino functional siloxane, the method comprising:
(1) providing a glass fiber depth filter; and
(2) in an acidic solution comprising water and a miscible organic solvent, contacting the glass fiber depth filter with an amino functional silane corresponding to one of the general structures:

Cl⁻N⁺R1R2R3-(CH₂)n-Si(X)₃

or

NR1R2-(CH₂)n-NR3-(CH₂)m-Si(X)₃

wherein
R1, R2, and R3 independently represent hydrogen, alkyl, cycloalkyl, aralkyl, or aryl;
n is an integer of 1 to 15;
m is an integer of 1 to 15; and
X represents alkoxy, acyloxy, halogen, or amine.

In another aspect, a quaternary amino functional siloxane-functionalized glass fiber depth filter is provided, the quaternary amino functional siloxane-functionalized glass fiber depth filter prepared by a process comprising:
(1) providing a glass fiber depth filter having a pore size of about 1.0 μm; and
(2) contacting the glass fiber depth filter with an acidic solution comprising water, a miscible organic solvent, and from about 1% to about 10% w/v of N-trimethoxysilylpropyl-N,N,N-trimethylammonium chloride.

In another aspect, a di-amino functional siloxane-functionalized glass fiber depth filter is provided, the di-amino functional siloxane-functionalized glass fiber depth filter prepared by a process comprising:
(1) providing a glass fiber depth filter having a pore size of about 1.0 μm; and
(2) contacting the glass fiber depth filter with an acidic solution comprising water, a miscible organic solvent, and from about 1% to about 10% w/v of N-(6-aminohexyl)aminopropyltrimethoxysilane.

### BRIEF DESCRIPTION OF THE FIGURES

The accompanying figures, which are incorporated in and constitute a part of the specification, illustrate various example systems, apparatuses, and processes, and are used merely to illustrate various example embodiments. In the figures, like elements bear like reference numerals.

FIG. 1 illustrates an example molecular interaction perspective of a glass fiber depth filter functionalized by a quaternary amino functional siloxane.

FIG. 2 illustrates example incorporation of a glass fiber depth filter 100 into a filter device 200.

FIG. 3A shows CE/SDS results on ProteinA purified samples in the nonreduced state after using a functionalized filter.

FIG. 3B shows CE/SDS results on ProteinA purified samples in the nonreduced state after using a conventional filter.

FIG. 4A shows CE/SDS results on ProteinA purified samples in the reduced state after using a functionalized filter.

FIG. 4B shows CE/SDS results on ProteinA purified samples in the reduced state after using a conventional filter.

FIG. 5A shows HPLC-SEC results on ProteinA purified samples after using a functionalized filter.

FIG. 5B shows HPLC-SEC results on ProteinA purified samples after using a conventional filter.

FIG. 6A is a protein elution profile overlay showing the results when using a functionalized filter versus using known industry filtration techniques.

FIG. 6B is a protein stain showing the results when using a functionalized filter versus using known industry filtration techniques.

FIG. 7A is a protein elution profile overlay showing the results when using a functionalized filter versus using known industry filtration techniques.

FIG. 7B is a protein stain showing the results when using a functionalized filter versus using known industry filtration techniques.

FIG. 8A is a protein elution profile overlay showing the results when using a functionalized filter versus using known industry filtration techniques.

FIG. 8B is a protein stain showing the results when using a functionalized filter versus using known industry filtration techniques.

### DETAILED DESCRIPTION

A functionalized glass fiber depth filter is provided, along with a method for making and using the filter. The glass fiber depth filter may be functionalized by a linear amino functional siloxane, e.g., a quaternary amino functional siloxane or a di-amino functional siloxane. The linear amine functional groups selectively absorb impurities, while the glass fiber depth filter physically separates via size exclusion through the torturous path of the media. The combination results in a synergistic improvement in throughput capacity of the subsequent 0.2 μm polyethersulfone (PES) membrane filter typically used by those skilled in the art for the final clarification step.

The functionalized glass filter significantly improves filter capacity and absorption of low molecular weight impurities such as host cell DNA and host cell proteins that would otherwise pass through a traditional depth filter and lead to PES filter clogging and failure. Further, the functionalized glass filter is sterilizable without limiting its effectiveness.

### Filter Selection

Appropriately selected depth filter media: (1) provide the optimal torturous path for impurities to be effectively captured in the matrix via size exclusion; and (2) allow for increased surface area for functional group addition. The relatively large surface area inherent in depth filter media allows for residence of more functional groups/cm² compared to thinner polymeric membrane media. A higher number of functional groups/cm² allows for a significant increase in capacity to absorb impurities. This is different in design and performance compared to functionalized multi-layer polymeric membrane absorbers such as Pall's Mustang Q/S that fail as prefilters and are intended for chromatography applications. The significantly reduced filter capacity that precludes the use of functionalized multi-layer polymeric membrane absorbers for the instant application comes from the fact that they are not a depth filter matrix, but a flat polymeric sheet and, therefore, clog more quickly.

Depth filter media selection is also important in maximizing cell culture impurity contact and exposure to functional groups. Pore size that is too large leads to less contact and reduced capacity. Pore size that is too small leads to clogging.

Further, depth filter media (glass fiber) may be binderless or binder-containing. Elimination of acrylic/epoxy-based binders/glue reduces a source of inherent media mineral/trace metal contaminants that can be introduced into the cell culture. However, as shown in Example 12, the use of glass fiber matrices with binders is achievable.

Depth filtration media used for functionalization may include composites/lenticular (DE-cellulose+epoxy derivatives and synthetic DE-non-woven+epoxy derivatives), non-wovens (cellulose, glass fiber, polypro), and polymers (PP, PE, PES, PVDF, and the like). Suitable depth filtration media may include, for example, Whatman® (part of Cytiva, a Danaher Company) glass microfiber filters, grade GF/B, GF/DVA, and GF/F, and Ahlstrom-Munksjo glass fiber equivalent grades, rated, e.g., 0.45 μm, 0.7 μm, 1 μm, and 2 μm to 5 μm.

### Functional Group Addition

Specific functional group addition is desirable to avoid binding IgG or HisTag proteins of interest, while increasing filter capacity. Functionalization may be carried out by chemical functionalization of surface groups of filtration media, e.g., via covalent bonding to hydroxyl groups or polymer coating of the media fibers. Functionalization chemistry may include any ligand with strong or weak anion exchange capacity, such as quaternary amines and tertiary amines.

In one aspect, the filter is functionalized with a silane coupling agent. In one aspect, the silane coupling agent is bi-functional and corresponds to the general structure: R—(CH2)2-Si-—X3, wherein X corresponds to a hydrolyzable group, typically alkoxy, acyloxy, halogen, or amine. Following hydrolysis, a reactive silanol group is formed, which can condense with other silanol groups, for example, those on the surface of siliceous filters (such as glass fiber-based filters) to form siloxane linkages. The R group corresponds to a nonhydrolyzable organic group, such as, for example, a quaternary amine or a di-amine.

The final result of reacting the silane coupling agent with the substrate, i.e., glass, silica, cellulose, or polymeric membranes, ranges from altering the wetting or adhesion characteristics of the substrate, using the substrate to catalyze chemical transformations at the heterogeneous interface to allow further functionalization via chemical linkage to the R group, e.g., linkage to a protein or enzyme, changing the contact angle of the substrate surface (hydrophobicity/oleophobicity/hydrophilicity), and modifying the substrate's partitioning characteristics via affinity, ion exchange, or hydrophobic interactions with a material passed through the matrix.

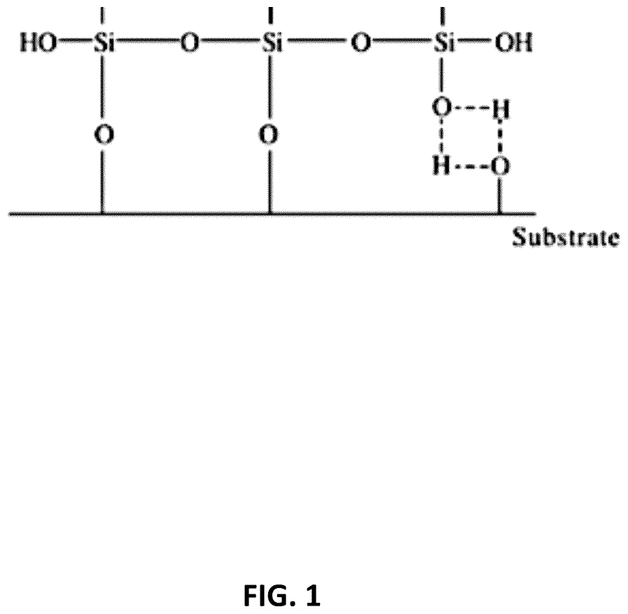

In some aspects, the silane coupling agents comprise one organic substituent and three hydrolyzable substituents. In some aspects, the hydrolyzable substituents are alkoxy groups. In some aspects, reaction of such silane coupling agents may be considered to involve four steps. First, the alkoxy groups are hydrolyzed to silanols. Second, the silanols are condensed to oligomers. Third, the oligomers hydrogen bond with hydroxy groups of the substrate. Finally, during drying or curing, a covalent linkage is formed with the substrate with concomitant loss of water. FIG. 1 illustrates an example molecular interaction perspective of a glass fiber depth filter functionalized by a quaternary amino functional siloxane.

Various chemistries and methodologies may be used to functionalize a substrate, including but not limited to liquid emersion, spray coating, and vapor deposition. Silane coupling agents may include, for example, trialkoxysilanes, dipodal silanes, and cyclic azasalines. Silanes can modify surfaces under anhydrous conditions as well, typically by vapor deposition with extended reaction times (4-12 h) at elevated temperatures (50° C.-120° C.).

Water for hydrolysis may already be present on or entrapped in the substrate, may be captured from the atmosphere, or may be added to a miscible organic solvent. Silane solubility may be affected by the organic solvent used. Typical solvents used are those that are miscible with water, including, for example, acetic acid, acetone, acetonitrile, dimethylformamide, DMSO, dioxane, ethanol, isopropanol, methanol, pentane, and 1-propanol.

Cyclic azasilanes exploit the Si-N and Si-O bond energy differences, affording a thermodynamically favorable ring-opening reaction with surface hydroxyls at ambient temperature. Sometimes referred to as “click-chemistry on surfaces,” the ring opening occurs through the cleavage of the inherent Si-N bond in these structures and promotes a strong covalent attachment to surface hydroxyl groups. This affords an organofunctional amine for further reactivity/interaction without the need for hydrolysis and condensation reactions.

Thus, in one aspect, a glass fiber depth filter is provided, the glass fiber depth filter being functionalized by a linear amino functional siloxane. In one aspect, the linear amino functional siloxane comprises a quaternary amino functional siloxane corresponding to the general structure:

Cl⁻N⁺R1R2R3-(CH₂)n-Si(O⁻)₃

wherein
R1, R2, and R3 independently represent hydrogen, alkyl, cycloalkyl, aralkyl, or aryl; and
n is an integer of 1 to 15.

In another aspect, the linear amino functional siloxane comprises a di-amino functional siloxane corresponding to the general structure:

NR1R2-(CH₂)n-NR3-(CH₂)m-Si(O⁻)₃

wherein
R1, R2, and R3 independently represent hydrogen, alkyl, cycloalkyl, aralkyl, or aryl;
n is an integer of 1 to 15; and
m is an integer of 1 to 15.

In another aspect, a method is provided for preparing a glass fiber depth filter functionalized by a linear amino functional siloxane, the method comprising:
(1) providing a glass fiber depth filter; and
(2) in an acidic solution comprising water and a miscible organic solvent, contacting the glass fiber depth filter with a quaternary amino functional silane corresponding to one of the general structures:

Cl⁻N⁺R1R2R3-(CH₂)n-Si(X)₃

or

NR1R2-(CH₂)n-NR3-(CH₂)m-Si(X)₃

wherein
R1, R2, and R3 independently represent hydrogen, alkyl, cycloalkyl, aralkyl, or aryl;
n is an integer of 1 to 15;
m is an integer of 1 to 15; and
X represents alkoxy, acyloxy, halogen, or amine.

In another aspect, a quaternary amino functional siloxane-functionalized glass fiber depth filter is provided, the quaternary amino functional siloxane-functionalized glass fiber depth filter prepared by a process comprising:
(1) providing a glass fiber depth filter having a pore size of about 1.0 μm; and
(2) contacting the glass fiber depth filter with an acidic solution comprising water, a miscible organic solvent, and from about 1% to about 10% w/v of N-trimethoxysilylpropyl-N,N,N-trimethylammonium chloride.

In another aspect, a di-amino functional siloxane-functionalized glass fiber depth filter is provided, the diamino functional siloxane-functionalized glass fiber depth filter prepared by a process comprising:
(1) providing a glass fiber depth filter having a pore size of about 1.0 μm; and
(2) contacting the glass fiber depth filter with an acidic solution comprising water, a miscible organic solvent, and from about 1% to about 10% w/v of N-(6-aminohexyl)aminopropyltrimethoxysilane.

In one aspect, the quaternary amino functional silane giving rise to the quaternary amino functional siloxane comprises N-trimethoxysilylpropyl-N,N,N-trimethylammonium chloride (the “Q” ligand):

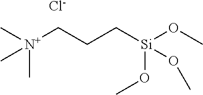

In one aspect, the di-amino functional siloxane comprises N-(6-aminohexyl)aminopropyltrimethoxysilane (the “ANX” ligand):

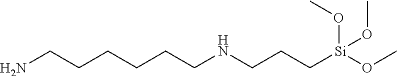 [SMILES: CO[Si](CCCNCCCCCCN)(OC)OC]

In one aspect, the functionalized filter may be encapsulated into a ready to use filter device, e.g., a bottletop filter equipped with a final 0.2 μm PES or larger surface areas via stackable disposable filter pads or spiral wound units. In one aspect, the functionalized filter may be sterilized. In one aspect, the functionalized filter may be used without flushing or other pretreatment. In one aspect, the functionalized filter may be scaled to various surface areas from small (˜25 mm²) to production scale (>˜25 m²) for biologic manufacturing. In one aspect, the functionalized filter may be suitable for the clarification of proteins of interest, including antibodies and tagged proteins, such as histidine-tagged proteins from mammalian cell cultures. In one aspect the functionalized filter may be suitable for the clarification of viral particles from mammalian cell cultures.

### EXAMPLES

The following enabling examples are merely intended to be non-limiting, illustrative examples of how to make and use the functionalized filters as claimed in the claims.

### Example 1: Example of General Preparation of Functionalized Filters

GELEST #SIT8415.0 (2% N-trimethoxysilylpropyl-N,N,N-trimethylammonium chloride (the “Q” ligand)) was added to a 500 mL glass beaker containing a 95:5 methanol to deionized water solution (PH ˜4 with no acetic acid adjustment). The mixture was stirred for 5 min to hydrolyze the silane.

A binderless Whatman® GF/B filter or GF/DVA, 1 μm or 2 μm respectively, was added to the solution and stirred slowly/agitated for 5 min. The filter was removed and rinsed with methanol. The filter was dried at room temperature overnight.

### Example 2: Filter Device Set-Up

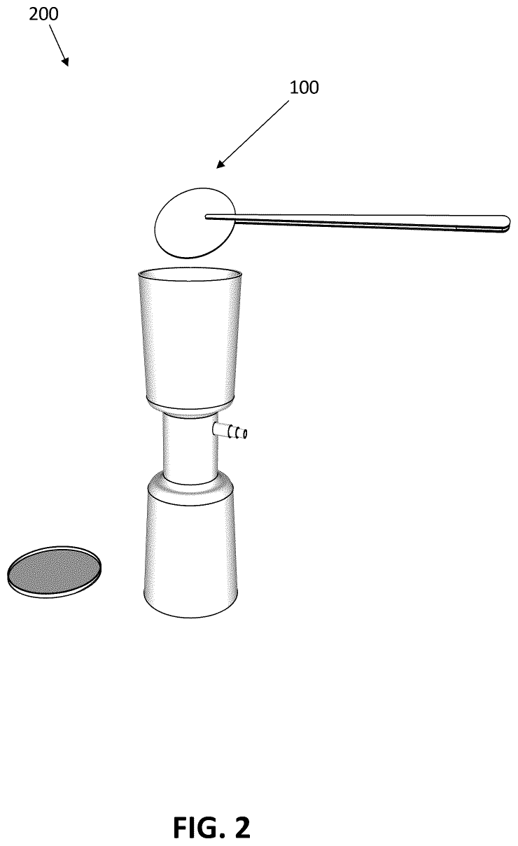

As shown in FIG. 2, the functionalized filter (100) from Example 1 was placed within a bottletop filter device 200 having a vacuum outlet 210 and containing a 0.2 μm PES membrane filter 220.

### Example 3: Q Ligand Loading Optimization

To identify the maximum percentage of functional ligand loading onto the glass fiber matrix, functionalization as described in Example 1 was carried out with 5% and 20% w/v of the Q ligand (“Q5%” and “Q20%,” respectively).

A 47 mm filter device (as shown in FIG. 2) comprising two 1 μm binderless or two 2 μm with binder functionalized glass filters (“GF1 μm” and “GF2 μm,” respectively)+a 0.2 μm PES was tested with HEK cell culture at 11e6/mL total cell density and 22% viability spun down using a floor centrifuge at 6.1K×g for 5 min to remove whole cells and large debris. The functionalized filters were tested against two untreated (UT) GF1 μm and two UT GF2 μm filters+a 0.2 μm PES as the control. 2 L of cell culture was transferred to a magnetic stir station after centrifugation to maintain homogeneity of the sample throughout testing.

Centrate was poured into the filter device under vacuum for 60 sec to measure flux (throughput) and inversely, decay (throughput reduction) as an indicator of filter clogging/impairment. Filtrate was measured via weight on an Ohaus 0.1 resolution scale. All values were rounded to the nearest whole number. The results are shown in Table 1.

TABLE 1

| | GF1 μm | GF2 μm | GF1 μm | UT | UT |
|---|---|---|---|---|---|
| | Q5% | Q5% | Q20% | GF1 μm | GF2 μm |
| Test 1 | 125 mL | 57 mL | 131 mL | 72 mL | 45 mL |
| Test 2 | 135 mL | 45 mL | 127 mL | 81 mL | 51 mL |
| Test 3 | 138 mL | 48 mL | 120 mL | 77 mL | 53 mL |

GF1 μm functionalized with Q5% and Q20% showed synergistically improved capacity, including compared to UT GF1 μm, indicating a positive impact of the Q ligand for filtrate capacity. Q5% and Q20% showed comparable performance, indicating maximum or adequate functionalization was achieved with 5% ligand loading.

All GF2 μm material performed poorly, indicating that the pore rating may be too large to capture submicron impurities. UT GF1 μm showed a small improvement over baseline, marking some benefit for size exclusion-based capture of submicron impurities or SEC and CEX absorption of impurities, perhaps due to the presence of hydroxyl groups on the fiber matrix.

Thus, GF1 μm-Q5% presents a synergistic advantage for single use clarification of submicron impurities.

### Example 4: Filtration of HEK293 Culture Expressing a Human IgG4

90 mm filter devices comprising four GF1 μm-Q5%+a 0.2 μm PES were tested with HEK cell culture at 15e6/mL total cell density and 19% viability spun down using a floor centrifuge at 6.1K×g for 5 min to remove whole cells and large debris. The GF1 μm-Q5% were tested against four UT GF1 μm+0.2μm PES as the control. 2 L of cell culture was transferred to a magnetic stir station after centrifugation to maintain homogeneity of the sample throughout testing.

Centrate was poured into the filter units under vacuum for 180 sec to measure flux and decay. The filtrate was measured via weight on an Ohaus 0.1 resolution scale. All values were rounded to the nearest whole number. The GF1 μm-Q5% showed no decline in flux, permitting throughput of 891 mL of filtrate and was only limited by elimination of applied culture sample. UT GF1 μm permitted throughput of only 635 mL of filtrate and clearly showed flux decay, with near stoppage of flux by the 180 sec mark.

### Example 5: Filtration of CHOK1 Stable Cell Line Expressing a Human IgG1

90 mm filter devices comprising two GF1 μm-Q5% and a 0.45 μm PES were tested with CHOK1 stable cell line culture at 16e6/mL Viable Cell Density and 85% viability spun down using a floor centrifuge at 6.1K×g for 5 min to remove whole cells and large debris. The GF1 μm-Q5% were tested against two UT GF1 μm+0.45 μm PES as the control. 2 L of cell culture was transferred to a magnetic stir station after centrifugation to maintain homogeneity of the sample throughout testing.

Centrate was poured into the filter units under vacuum for 180 sec to measure flux and decay. Filtrate was measured via weight on an Ohaus 0.1 resolution scale. All values were rounded to the nearest whole number. The GF1 μm-Q5% showed no decline in flux, permitting throughput of 963 mL of filtrate and was only limited by elimination of applied culture sample. UT GF1 μm permitted throughput of only 297 mL of filtrate and clearly showed flux decay, with near stoppage of flux by the 180 sec mark.

### Example 6: Analytical Results of Purified IgG From Harvested Material

Purification and analytical assessment of protein attributes from the filtrate of Example 5 were carried out to confirm that GF1 μm-Q5% did not affect protein quality attributes. Thus, 100 mL of filtered culture material was purified via ProteinA affinity chromatography. The eluted peak was quantified via UV/VIS spectrophotometry at A280. The yield of the purified protein and the titer are shown in Table 2.

TABLE 2

| | | Titer |
|---|---|---|
| | Yield | (projection for normalized |
| | (purified protein) | value of g/L) |
| GF1 μm -Q5% | 242.49 mg | 2.42 g/L |
| UT GF1 μm | 255.31 mg | 2.55 g/L |

The small difference (˜5%) in yield between GF1 μm -Q5% and UT GF1 μm is well within the mean of expected results and can be attributed to process variability.

CE/SDS and HPLC-SEC Analytics were run on ProteinA purified samples in both reduced and nonreduced states to confirm that GF1 μm -Q5% did not cause degradation or aggregation of IgG. Both tests confirm that GF1μm-Q5% results are in line with UT GF1 μm.

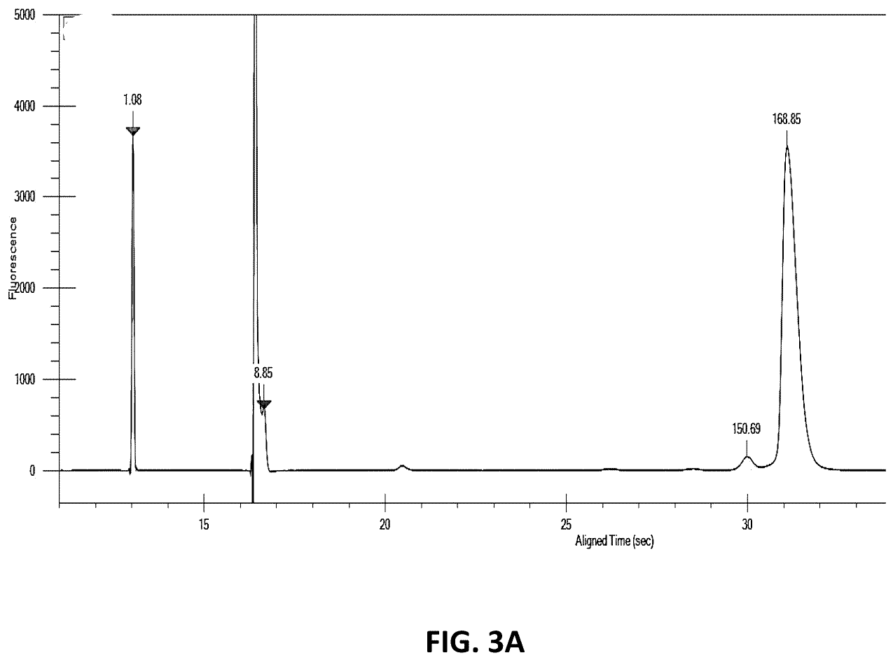

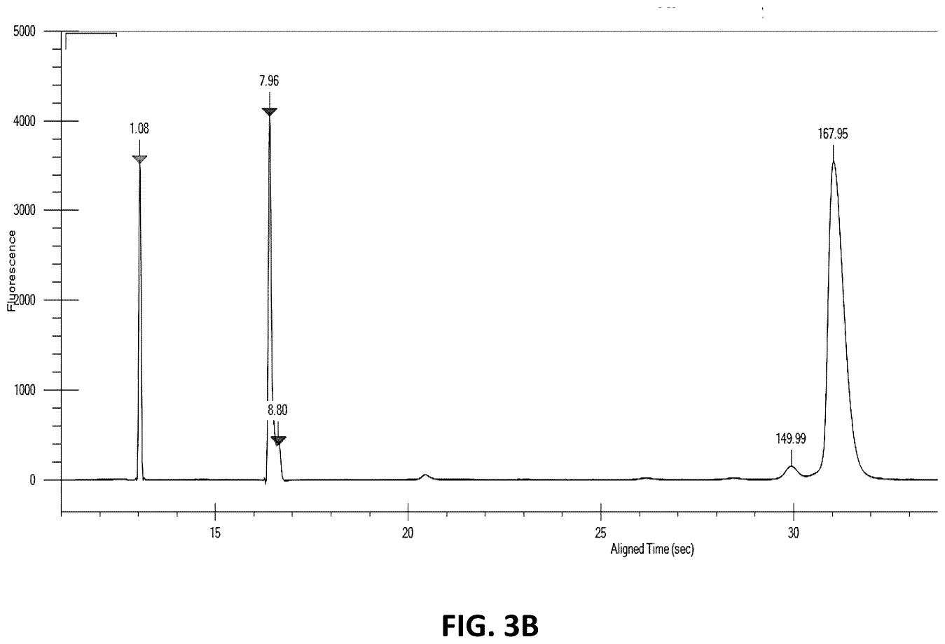

FIG. 3A shows GF1 μm-Q5% CE/SDS (Perkin Elmer LabChip GXIII) results on ProteinA purified samples in the nonreduced state.

FIG. 3B shows UT GF1 μm CE/SDS (Perkin Elmer LabChip GXIII) results on ProteinA purified samples in the nonreduced state.

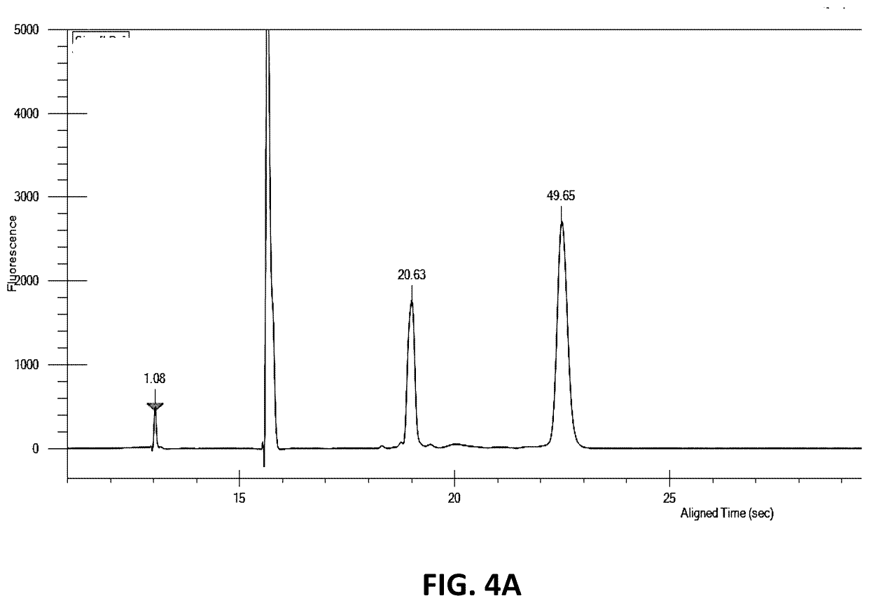

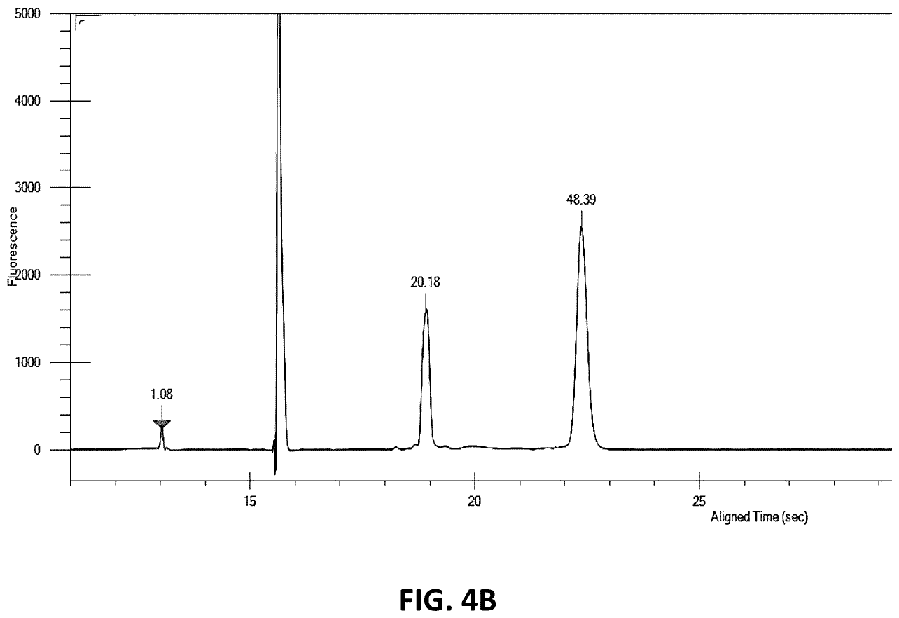

FIG. 4A shows GF1 μm-Q5% CE/SDS (Perkin Elmer LabChip GXIII) results on ProteinA purified samples in the reduced state.

FIG. 4B shows UT GF1 μm CE/SDS (Perkin Elmer LabChip GXIII) results on ProteinA purified samples in the reduced state.

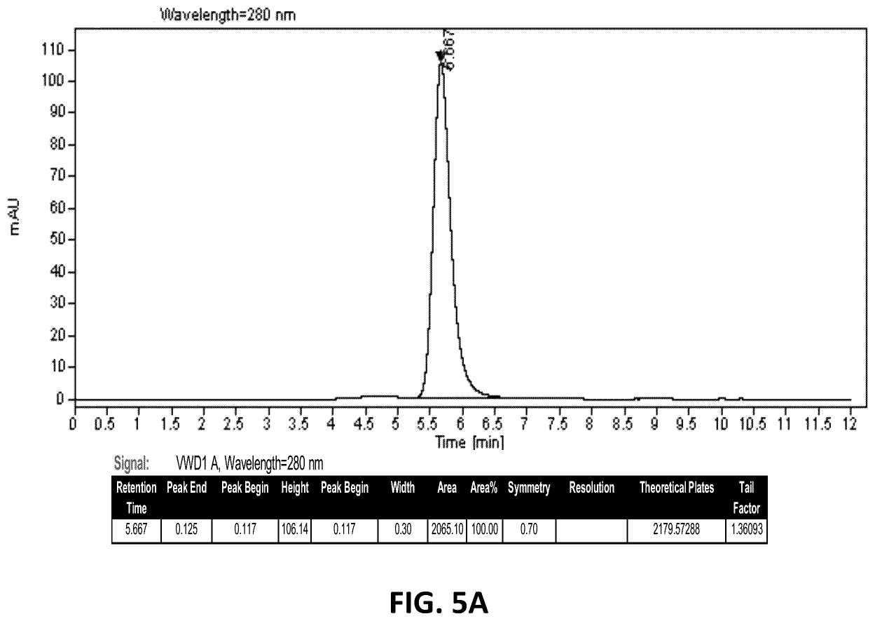

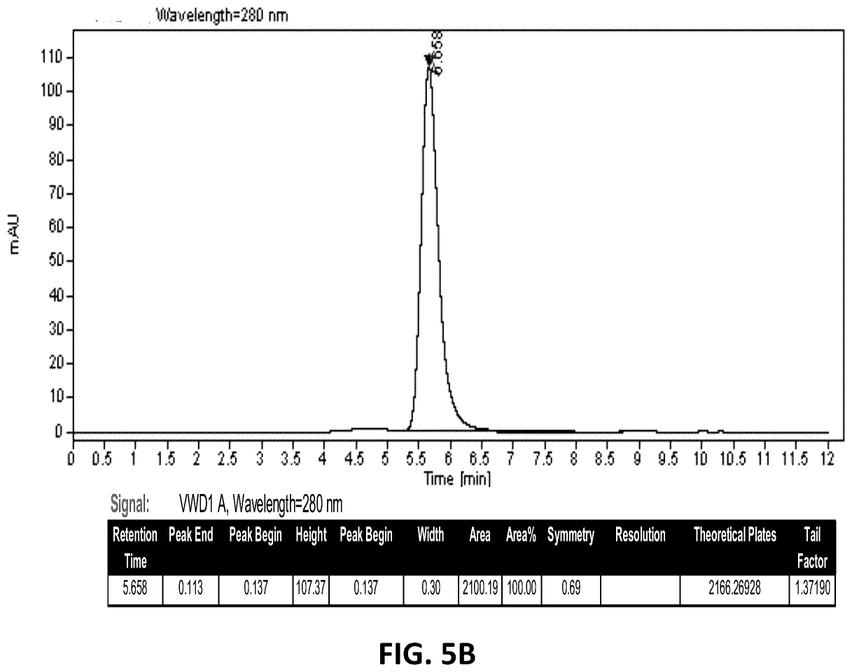

FIG. 5A shows GF1 μm -Q5% HPLC-SEC (Agilent HPLC using an SEC column) results.

FIG. 5B shows UT GF1 μm HPLC-SEC (Agilent HPLC using an SEC column) results.

### Example 7: Filtration of HEK293 Culture Expressing Three Different Histidine x6 Tagged Proteins

HEK293 culture expressing three different His tagged proteins were tested for capacity/throughput of the filter, as well as protein quality attributes post-filtration. Thus, 47 mm filter devices comprising three GF1 μm-Q5%+a Q5%-treated 0.2 μm PES were tested. Treatment of the PES with the same 5% Q ligand functionalization protocol was carried out to change the surface charge of the PES from net negative to net positive. HEK cell culture at 13e6/mL total cell density and 20% viability was spun down using a floor centrifuge at 6.1K×g for 5 min to remove whole cells and large debris. The GF1 μm-Q5%+Q5%-treated 0.2 μm PES (designated as “47 mm”) were tested against: (1) non-centrifuged, purified diatomaceous earth (SartoClear-Sartorius)+untreated 0.2 μm PES (designated as “wDE”); and (2) spun down centrate poured over untreated 0.2 μm PES (designated as “xDE”) as the control. 1 L of cell culture of each protein was transferred to a magnetic stir station after centrifugation to maintain homogeneity of the sample throughout testing.

A third His tagged protein sample was tested with two 90 mm GF1 μm-Q5% filters+a 0.2 μm 76 mm cellulose nitrate (CN) filter (designated as “90 mm”). This deviation allowed for comparison of the treated 0.2 μm PES versus the 0.2 μm CN final filters.

Centrate was poured into the filter units under vacuum with a defined volume of culture, 150 mL, to measure flux and maintain total protein quantity in all three samples. Non-centrifuged culture was used for the wDE sample. The filtrate was measured via weight on an Ohaus 0.1 resolution scale. All values were rounded to the nearest whole number.

Time of filtration was not recorded but was observed as fast/no blockage for all GF1 μm-Q5% and DE-based clarifications, while centrate+standard PES was extremely slow to process the 150 mL. The results are shown in Table 3.

TABLE 3

| | 3GFQ + 0.2 μm *tPES | | DE + 0.2 μm PES | | 0.2 μm PES | |
|---|---|---|---|---|---|---|
| Sample 1 | 150 mL | ~90 sec | 150 mL | ~90 sec | 150 mL | ~30 min |
| Sample 2 | 150 mL | ~90 sec | 150 mL | ~90 sec | 150 mL | ~30 min |
| | 2 GFQ + 0.2 μm CN | | DE + 0.2 μm PES | | 0.2 μm PES | |
| Sample 3 | 150 mL | ~90 sec | 150 mL | ~90 sec | 150 mL | ~30 min |

Three proteins (all His tagged) were expressed in HEK293:
Sample 1: ˜37 kDa
Sample 2: ˜54 kDa
Sample 3: ˜60 kDa

The proteins were purified using 1 mL NiNTA-FF resin on AKTA Explorer. 50 mL clarified supernatant was loaded.

Elution:
Linear gradient to 250 mM imidazole.
250 mM imidazole hold for 3 CV.
Step to 500 mM imidazole.

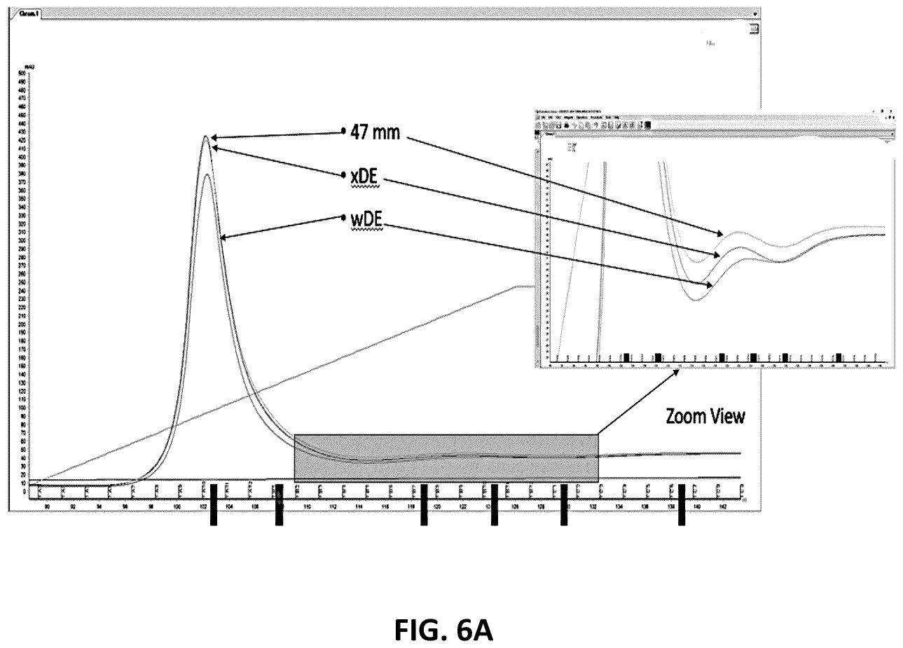

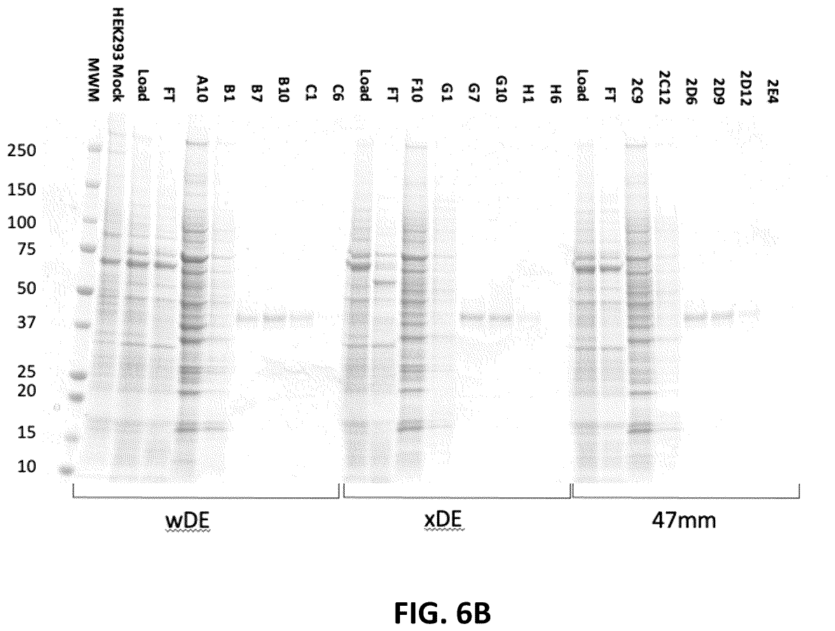

FIG. 6A shows Sample 1's protein elution profile overlay comparing 47 mm with wDE and xDE. The fractions were run on reducing SDS-PAGE gels. The early eluting large peak is non-specific contaminants. The zoom view shows specific eluates.

FIG. 6B shows Sample 1's protein stain comparing 47 mm with wDE and xDE.

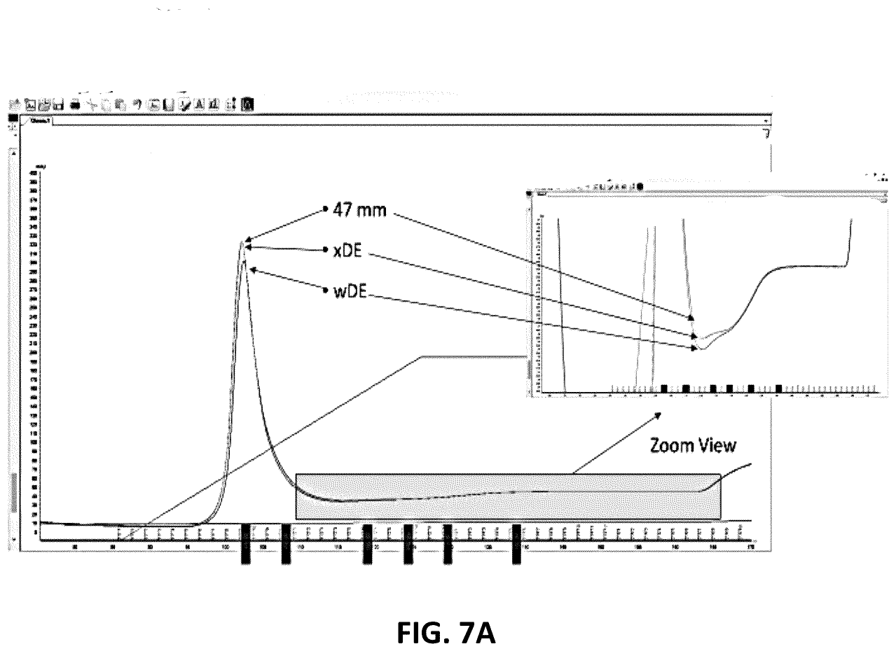

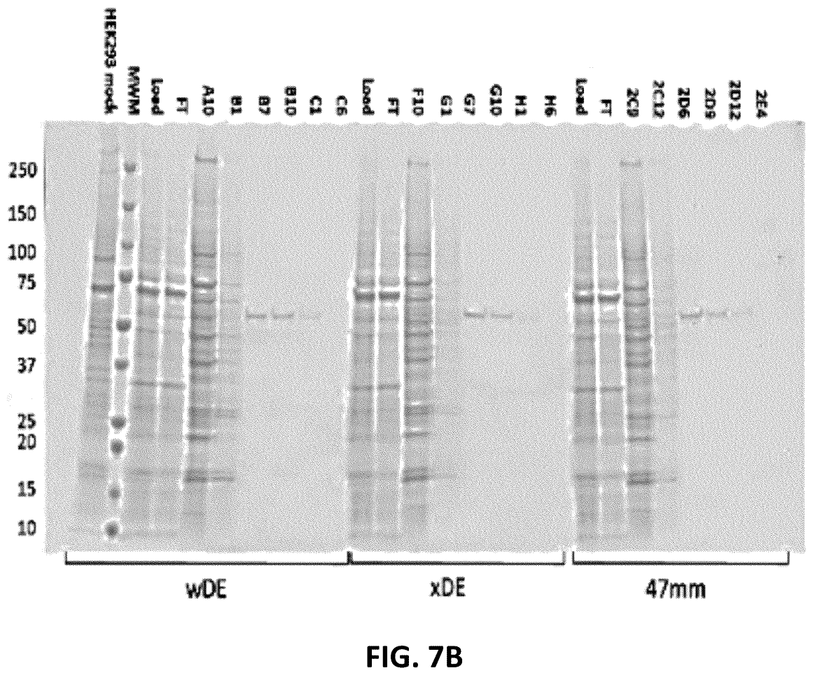

FIG. 7A shows Sample 2's protein elution profile overlay comparing 47 mm with wDE and xDE. The fractions were run on reducing SDS-PAGE gels. The early eluting large peak is non-specific contaminants. The zoom view shows specific eluates.

FIG. 7B shows Sample 2's protein stain comparing 47 mm with wDE and xDE.

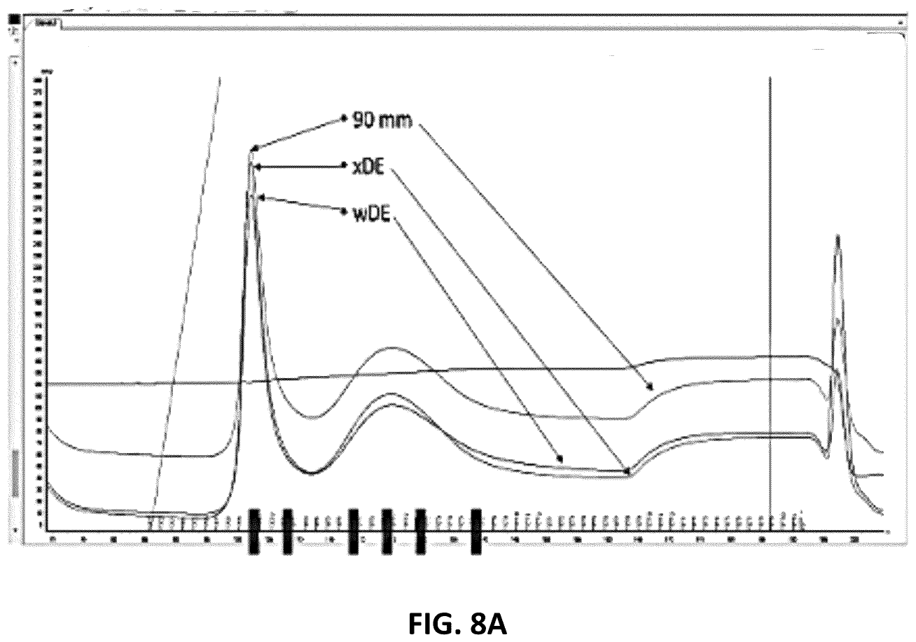

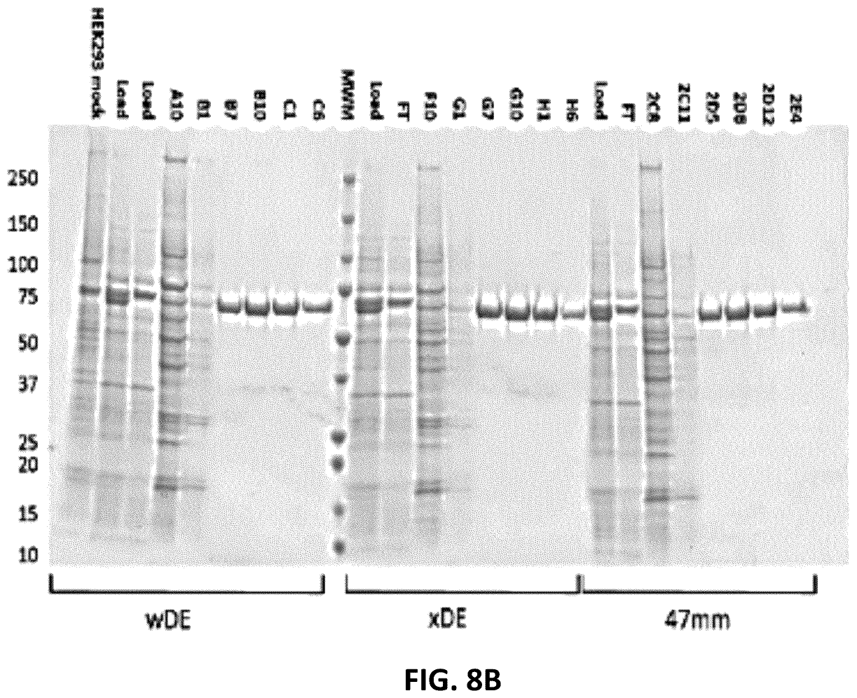

FIG. 8A shows Sample 3's protein elution profile overlay comparing 90 mm with wDE and xDE. The fractions were run on reducing SDS-PAGE gels. The early eluting large peak is non-specific contaminants.

FIG. 8B shows Sample 3's protein stain comparing 90 mm with wDE and xDE.

The functionalized filters tested show comparable, if not slightly better, protein titer for all proteins based on AKTA UV traces as compared to two different current industry harvest techniques. The gels show comparable protein quality, thereby confirming that the functionalized filters do not have an impact on protein quality for the three different His tagged proteins used in this study. Sample 3 with final 0.2 μm CN shows significant improvement in protein recovery via UV trace. This may indicate PES interaction with His tagged proteins.

### Example 8: HEK293 Culture Expressing a His Tagged Protein of ˜54kD

90 mm filter devices comprising four GF1 μm-Q5%+a Q5%-treated 0.2 μm PES were tested with HEK cell culture at 16e6/mL total cell density and 22% viability spun down using a floor centrifuge at 6.1K×g for 5 min to remove whole cells and large debris. The GF1 μm-Q5%+Q5%-treated 0.2 μm PES were tested against centrate poured directly over 0.2 μm PES as the control. 2 L of cell culture was transferred to a magnetic stir station after centrifugation to maintain homogeneity of the sample throughout testing.

Centrate was poured into the filter units under vacuum without time restriction to measure maximum capacity or throughput and decay. The filtrate was measured via weight on an Ohaus 0.1 resolution scale. All values were rounded to the nearest whole number. The GF1 μm-Q5%+Q5%-treated 0.2 μm PES showed no impairment after a full 1 L+ of sample was filtered in 5 min, 6 sec. The control immediately exhibited flux decay, indicating pore blockage, and permitted only 109 mL to pass through. Vacuum for the control was discontinued following 3 min.

Demonstration of GF1 μm -Q5% versus current harvest techniques employed by the industry shows clear improvement in capacity with no impact on protein quality attributes. Relevance with the three main mammalian culture types used in the life science industry for production of proteins was demonstrated: transient HEK for IgG proteins; stable CHO for IgG proteins; and transient HEK for His tagged proteins.

While both showed marked improvement over controls, speed of filtration of 1 L of IgG vs His tagged proteins expressed in the same HEK cell line under similar shake flask culture conditions points to interactions with the final membrane filter even with PES treatment as a possible cause for LMH reduction (how long it took to filter ˜1 L) for transient His tagged proteins (5 min, 6 sec) versus IgG (1 min, 30 sec).

All experiments were carried out by vacuum filtration due to simplicity of devices and ease of use for laboratory scale work. This creates filtration under extremely high application with a natural limitation of 1 L due to the size of the collection vessel of the filter unit. Therefore, the maximum capacity of the 90 mm GF1 μm -Q5% filters was not reached. This has relevance for further scale up above 1 L, where positive pressure via pumping can be used and separation of final 0.45/0.2/0.1 μm polymeric PES filter can be employed. For example, processing of even 1 L of stable CHO via a 90 mm device which ends in a 0.45 μm PES in 90 sec equates to 159 L/m2, but at 6,349 L/m2*H. As is known by those skilled in the art, reduction in application speed (LMH) will increase overall capacity (L/m2). At large scale, controlled application by positive pressure at lower application speeds, higher transmembrane pressures and separation of the GF1 μm-Q5% filter from the PES final filter will translate into significant L/m2 improvements over GF1 μm-Q5% only devices. Since one goal is protection and improved performance of the 0.45/0.2 μm polymeric PES filter, it was decided to test the technology under market relevant conditions that demonstrate the technology at laboratory scale with the understanding that it does not demonstrate the full potential of the technology for process applications.

### Example 9: Quantification of DNA Binding Capacity

To confirm and quantify the binding capacity of the GF1 μm-Q5% and GF2μm-Q5% filters, a DNA binding experiment was carried out using purified plasmid DNA (pDNA). Each sample was comprised of 10 mL PBS buffer containing pDNA. The pDNA concentration of the samples were measured pre-and post-filtration via UV spectroscopy. The difference between the starting and ending concentration was considered to inversely correlate to the amount of pDNA bound to the filter. The samples were run in triplicate over new single 47 mm GF1 μm-Q5% and GF2μm-Q5% filters, as shown in Tables 4 and 5:

TABLE 4
GF1 μm -Q5% pDNA Binding Capacity

| | Pre-Filtration pDNA | Post-Filtration pDNA |
|---|---|---|
| Sample No. | Concentration (ng/μL) | Concentration (ng/μL) |
| 1 | 50 | 20 |
| 2 | 52 | 20 |
| 3 | 53 | 17 |

Thus, for an average pre-filtration pDNA concentration of 51.7 ng/μL and an average post-filtration DNA concentration of 19 ng/μL, the difference is 32.7 ng/μL or 32.7 μg/mL. For a 10 mL sample, the amount of pDNA bound to GF1 μm-Q5% is 327 μg. The binding capacity for the GF1 μm-Q5% filter is thus 327 μg/17 cm²=19.2 μg/cm².

TABLE 5
GF2 μm -Q5% pDNA Binding Capacity

| | Pre-Filtration pDNA | Post-Filtration pDNA |
|---|---|---|
| Sample No. | Concentration (ng/μL) | Concentration (ng/μL) |
| 1 | 69 | 55 |
| 2 | 72 | 55 |
| 3 | 72 | 53 |

Thus, for an average pre-filtration pDNA concentration of 71.0 ng/μL and an average post-filtration DNA concentration of 54.3 ng/μL, the difference is 16.7 ng/μL or 16.7 μg/mL. For a 10 mL sample, the amount of pDNA bound to GF2μm-Q5% is 167 μg. The binding capacity for the GF2μm-Q5% filter is thus 167 μg/17 cm2 =9.8 μg/cm2.

Both filter types were confirmed to bind DNA, indicating that the Q ligand binds DNA. The GF1 μm-Q5% filter has nearly double the binding capacity of the GF2μm-Q5% filter. This binding capacity difference can be explained by the difference in the particle retention ratings. While the GF1 μm -Q5% filter and the GF2μm-Q5% filter contain similar grammage and thicknesses, the more open GF2μm-Q5% filter has more space between the fibers through which sample can flow without interaction proximity to the functional groups on the surface of the fibers. This result also correlates to the filtration capacity values seen in Example 3, where the GF1 μm-Q5% filter proved effective in enhanced performance vs control, but the GF2μm-Q5% filter did not. Again, this is likely due to the fact that the GF2μm-Q5% filter is too open to effectively bind DNA and other submicron impurities, instead allowing the impurities to pass through and clog the downstream 0.2 pm PES filter.

### Example 10: Stability of the GF1 μm -Q5% Filter to Electron Beam Sterilization

To confirm the ability of the GF1 μm -Q5% filter to be irradiated as an indicator of sterilization, a study of performance of electron beam irradiated GF1 μm-Q5% filters versus non-sterile GF1 μm-Q5% filters was performed.

A single lot of GF1 μm-Q5% filters was prepared as described in Example 1 and was split into two groups. “Group 1” was double-bagged and subjected to electron beam sterilization. The electron beam irradiation was conducted at a 30-40 kYg dosage commonly used for laboratory and medical product sterilization. “Group 2” was double bagged and stored at room temperature as a non-sterile control.

A 90 mm filter device comprising two GF1 μm -Q5% filters from Group 1+0.2 μm PES was prepared. A 90 mm filter device comprising two GF1 μm-Q5% filters from Group 2+0.2 μm PES was also prepared.

HEK293 Transient Culture expressing a human IgG1 was tested for capacity/throughput of the Group 1 and Group 2 filters. Thus, HEK cell culture at 13.4e6/mL total cell density and 55% viability was spun down using a floor centrifuge at 6.1K×g for 5 min to remove whole cells and large debris. 2 L of cell culture was transferred to a magnetic stir station after centrifugation to maintain homogeneity of the sample throughout testing.

Centrate was poured into the filter units under vacuum to measure flux and decay. Measurement of filtrate was taken visually at 1 min, 2 min, and at 2.5 min, when significant flux decay occurred. The final filtrate at 2.5 min was measured via weight on an Ohaus 0.1 resolution scale. All values were rounded to nearest whole value.

TABLE 6

| Group No. | 1 min | 2 min | 2.5 min |
|---|---|---|---|
| 1 | ~550 mL | ~695 mL | ~708 mL |
| 2 | ~550 mL | ~655 mL | ~677 mL |

Groups 1 and 2 were consistent. Only two prefilters were used to better ensure flux decay as an additional comparison point between sterile and non-sterile filters. While max capacity and flux decay were slightly better for the sterilized (Group 1) filters, this is likely attributable to test variability, rather than an actual flux improvement in the filter due to sterilization. While formal sterilization validation was not carried out, the dosage and process for irradiation were replicated. The goal for this initial experiment was to show that common irradiation methodology does not impact performance, thereby confirming the single use utility of the functionalized filters.

### Example 11: N-(6-aminohexyl)aminopropyltrimethoxysilane

To evaluate the performance of various amine-based chemistries on performance, additional ligands were fixed onto the glass fiber matrix. Thus, in one example, the ANX ligand was used to prepare a 1 μm N-(6-aminohexyl)aminopropyltrimethoxysilane (GELest #SIA0594.0)-functionalized filter (“ANX1 μm”) with 5% w/v of ligand as described in Example 1.

A 47 mm filter device comprising two ANX1 μm+a 0.2 μm PES was tested with HEK cell culture at 12e6/mL total cell density and 59% viability spun down using a floor centrifuge at 6.1K×g for 5 min to remove whole cells and large debris. The ANX1μm functionalized filters were tested versus two GF1 μmQ5%+a 0.2 μm PES as the control. 2 L of cell culture was transferred to a magnetic stir station after centrifugation to maintain homogeneity of the sample throughout testing. Samples were run in duplicate.

Centrate was poured into the filter device under vacuum for 90 sec to measure flux and decay. Filtrate was measured via weight on an Ohaus 0.1 resolution scale. All values were rounded to the nearest whole number. The results are shown in Table 7.

TABLE 7

| | GF1 μm | ANX1 μm |
|---|---|---|
| | Q5% | 5% |
| Test 1 | 135 mL | 133 mL |
| Test 2 | 142 mL | 166 mL |

The ANX ligand works as well GF1 μmQ5% and confirms that both weak and strong amine chemistry have affinity for mammalian cell culture impurities. The linearity and lack of steric hindrance of each molecule permit interaction between impurities and the amine sites, despite differences in the strength of the positive charge about the amine(s), number of amines (1 vs 2), location of amines (end only vs end+middle), and length of linker.

### Comparative Example 1: N-(trimethoxysilylethyl)benzyl-N,N,N-trimethylammonium chloride

In another example, Example 3 was repeated using 5% and 20% w/v of N-(trimethoxysilylethyl)benzyl-N,N,N-trimethylammonium chloride (the “MQ” ligand; thus, “MQ5%” and “MQ20%,” respectively):

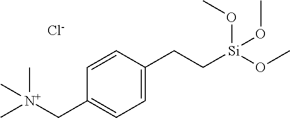

A 47 mm filter device comprising two of either a GF1 μm or a GF2μm+a 0.2 μm PES was tested with HEK cell culture at 11e6/mL total cell density and 22% viability spun down using a floor centrifuge at 6.1K×g for 5 min to remove whole cells and large debris. The functionalized filters were tested against two UT GF1 μm and two UT GF2μm filters+a 0.2 μm PES as the controls. 2 L of cell culture was transferred to a magnetic stir station after centrifugation to maintain homogeneity of the sample throughout testing.

Centrate was poured into the filter device under vacuum for 60 sec to measure flux and decay. Filtrate was measured via weight on an Ohaus 0.1 resolution scale. All values were rounded to the nearest whole number. The results are shown in Table 8.

TABLE 8

| | GF1 μm | GF2 μm | GF1 μm | UT | UT |
|---|---|---|---|---|---|
| | MQ5% | MQ5% | MQ20% | GF1 μm | GF2 μm |
| Test 1 | 55 mL | 49 mL | 57 mL | 72 mL | 45 mL |
| Test 2 | 59 mL | 51 mL | 45 mL | 81 mL | 51 mL |
| Test 3 | 49 mL | 44 mL | 48 mL | 77 mL | 53 mL |

The MQ ligand-functionalized filters performed poorly regardless of pore size, and, in fact, performed worse than untreated glass fiber filters.

### Comparative Example 2: trimethoxysilylpropyl modified (polyethylenimine)

In another example, a 1 μm trimethoxysilylpropyl modified (polyethylenimine) (GELest #SSP-060)-functionalized filter (“PEI1 μm”) was prepared with 5% w/v of ligand as described in Example 1:

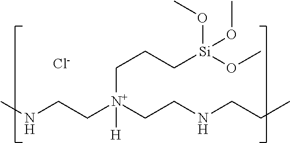

A 47 mm filter device comprising two PEI1 μm+a 0.2 μm PES was tested with HEK cell culture at 12e6/mL total cell density and 59% viability spun down using a floor centrifuge at 6.1K×g for 5 min to remove whole cells and large debris. The PEI1 μm functionalized filters were tested vs. two GF1 μmQ5%+a 0.2 μm PES as the control. 2 L of cell culture was transferred to a magnetic stir station after centrifugation to maintain homogeneity of the sample throughout testing. Samples were run in duplicate.

Centrate was poured into the filter device under vacuum for 90 sec to measure flux and inversely, decay as an indicator of filter clogging/impairment. Filtrate was measured via weight on an Ohaus 0.1 resolution scale. All values were rounded to the nearest whole number. The results are shown in Table 9.

TABLE 9

| | GF1 μm | PEI1 μm |
|---|---|---|
| | Q5% | 5% |
| Test 1 | 135 mL | 5.2 mL |
| Test 2 | 142 mL | 19 mL |

The PEI1 μm 5% filters immediately clogged. PEI is a highly branched polymer and much larger than the Q ligand and ANX. Without wishing to be bound by theory, the challenges faced with PEI and MQ-functionalized filters may be explained as follows:

In the case of PEI, the ligand's large polymeric nature may create more opportunities for the ligand to self-react, creating multi-ligand branching anchored on only one ligand silanol base. This creates an inconsistent fiber morphology with secondary reactions, which can break off into the sample solution, acting as an aggregator of impurities (similar to a flocculent) or directly binding to the negatively charged PES membrane. Quick aggregation in the time between the initial interaction in PEI filter and contacting the PES filter creates complexes (i.e., DNA/phospholipid impurity+PEI) that are still too small to be captured in the PEI filter but are too large to pass through the 0.2 μm PES.

Further in the case of PEI, the ligand may create a net-like matrix that impedes clearance between the void volume of the glass fibers, effectively reducing the intra-fiber space to sub-micron levels, which is too constrictive to allow bulk flow.

In the case of PEI and MQ, the steric bulk of the ligand may reduce or prohibit interaction between the DNA/phospholipid impurity and the amine moiety.

### Example 12: Functionalization of a Binder-Containing Glass Fiber Filter

Pleated filter cartridges/capsule matrixes of glass fiber sheets typically include binders. To assess the qualitative and quantitative performance of glass fiber matrices that include binders, the following experiments were conducted.

To keep testing consistent, all tests were carried out via vacuum filtration as previously described. Binder-containing glass fiber matrices of ˜350 μm thickness, 75 g/m2, and which are rated as an approximation of 1 μm-0.7 μm nominal retention value (Cytiva GF6 or “GF6”) were functionalized with the ANX ligand. To maintain the same relative total fiber thickness as the binderless counterpart, eight GF6 filters were laid on top of the final 0.2 μm PES. This would roughly equate to a stack of four GF1 μm prefilters from previous experiments (GF1 μm matrix: 680 μm×4 versus GF6 matrix 350 μm×8).

Thus, a 90 mm filter device comprising eight GF6ANX+0.2 μm PES was prepared as described in Example 1. HEK cell culture at 13e6/mL total cell density and 46% viability was spun down using a floor centrifuge at 6.1K×g for 5 min to remove whole cells and large debris. 2 L of cell culture was transferred to a magnetic stir station after centrifugation to maintain homogeneity of the sample throughout testing. Eight layers of UT GF6+0.2μm PES were tested as a control.

Centrate was poured into filter units under vacuum for a set period of time (90 sec) to

measure flux and decay. Filtrate was measured via weight on an Ohaus 0.1 resolution scale. All values were rounded to nearest whole value. The results are shown in Table 10.

TABLE 10

| | Time (sec) | | | | | | | | | | | |
|---|---|---|---|---|---|---|---|---|---|---|---|---|
| | 0 | 30 | 60 | 90 | 120 | 150 | 180 | 210 | 240 | 270 | 300 | 330 |
| GF6ANX | 0 | 290 | 410 | 500 | 590 | 640 | 690 | 730 | 775 | 805 | 840 | 876 |
| Test 1 | | | | | | | | | | | | |
| UT GF6 | 0 | 285 | 380 | 430 | 460 | 466 | 469 | 469 | 469 | 469 | 469 | 469 |

The experimental results indicate three general conclusions:

Functionalization of a binder-containing glass fiber matrix yields performance improvements in line with what was seen with binderless glass fiber matrices.

The slightly tighter size retention rating of the base matrix being 0.7 μm versus the previously tested 1 μm did not significantly affect base flux/decay profiles. While in theory, the tighter matrix should help with particle retention, in fact, 0.7 μm and 1 μm matrices are relatively similar in performance, indicating that the impurities challenging the 0.2 μm PES are smaller than 0.7 μm.

The functionalization of glass fiber matrices can be accomplished across various thicknesses, retention ratings, and binder/binderless formats. As long as silanol —OH groups are available, functionalization can occur. This allows for multi-attribute tuning of thickness and multistage/asymmetric configurations based on retention and/or ligand chemistries to optimize for specific cell culture conditions within clarification of biologics or for other life science applications such as Host Cell DNA clearance.

### Example 13: Effect of Filter Construct Thickness on Volumetric Throughput of the Final 0.2 μm PES Filter

It has been discovered that an increase in filter construct thickness correlates to an increase in volumetric throughput of the final 0.2 μm PES filter. Table 11 shows the flux performance of four layers versus two layers of binderless functionalized GF1 μm-Q5% (using 12-15e6/mL total cell density mammalian HEK cells, 40-60% viable):

TABLE 11

| | Time (sec) | | | | | | | | | | |
|---|---|---|---|---|---|---|---|---|---|---|---|
| | 0 | 30 | 60 | 90 | 120 | 150 | 180 | 210 | 240 | 270 | 300 |
| GF1 μm- | 0 | 350 | 550 | 675 | 760 | 825 | 875 | | | | |
| Q5% | | | | | | | | | | | |
| (4 filters) | | | | | | | | | | | |
| Test 1 | | | | | | | | | | | |
| UT GF1 μm | 0 | 275 | 425 | 475 | 525 | 570 | 605 | | | | |
| (4 filters) | | | | | | | | | | | |
| GF1 μm- | 0 | 250 | 505 | 650 | 775 | 840 | 910 | 950 | | | |
| Q5% | | | | | | | | | | | |
| (4 filters) | | | | | | | | | | | |
| Test 2 | | | | | | | | | | | |
| UT GF1 μm | 0 | 285 | 375 | 405 | 425 | 435 | 450 | 455 | | | |
| (1 filter) | | | | | | | | | | | |
| Irradiated | 0 | 400 | 550 | 625 | 675 | 705 | 750 | 770 | 795 | | |
| GF1 μm- | | | | | | | | | | | |
| Q5% | | | | | | | | | | | |
| (2 filters) | | | | | | | | | | | |
| Non- | 0 | 400 | 525 | 605 | 650 | 680 | 710 | 735 | 755 | | |
| irradiated | | | | | | | | | | | |
| GF1 μm- | | | | | | | | | | | |
| Q5% | | | | | | | | | | | |
| (2 filters) | | | | | | | | | | | |
| GF6ANX | 0 | 290 | 410 | 500 | 590 | 640 | 690 | 730 | 775 | 805 | 840 |
| (8 filters) | | | | | | | | | | | |

| | | | | | | | | | |
|---|---|---|---|---|---|---|---|---|---|
| UT GF6 | 0 | 285 | 380 | 430 | 460 | 466 | 469 | 469 | 469 |
| (8 filters) | | | | | | | | | |

There is an improvement in flux performance for 4 layers versus 2 layers of GF1 μm-Q5%. An incremental increase was observed for UT controls of 1 layer vs 4 layers as well, indicating that both a physical increase in thickness or the length of torturous path (size based separation) through which the sample passes, as well as the presence of the amine functional group contribute to the overall clearance capacity of the technology.

The GF6 ANX (eight filters) performance was very similar to the two layer GF1 μm -Q5% performance, even though the grammage and thickness of the eight layers of matrix were closer to the four layer GF1 μm -Q5% (350 μm, 70g/m2×8 versus 675 μm, 143g/m2×4). One consideration may be whether the binder reduces the available functional sites on the fiber and, thus, reduces the overall binding capacity/cm2 of the filter.

Another consideration may be whether the physical characteristics of the matrix (thinner with binder) create inefficiencies in size exclusion-based clearance due to layering effects; stated another way, whether the fact that the UT GF6 matrix displayed profiles similar to a single layer of UT GF1 μm indicates that the GF6 matrix is less efficient in physical entrapment of impurities than the binderless glass fiber format used in this study.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of alternative aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A glass fiber depth filter, the glass fiber depth filter being functionalized by an amino functional siloxane, the amino functional siloxane corresponding to the general structure:
Cl⁻N⁺R1R2R3-(CH₂)n-Si(O⁻)₃
wherein
R1, R2, and R3 independently represent hydrogen, alkyl, cycloalkyl, aralkyl, or aryl, and
n is an integer of 1 to 15.

2. The glass depth filter of claim 1, wherein R1, R2, and R3 independently represent H or alkyl.

3. The glass depth filter of claim 1, wherein R1, R2, and R3 independently represent methyl.

4. The glass depth filter of claim 1, wherein n is 3.

5. The glass depth filter of claim 1, wherein R1, R2, and R3 independently represent methyl and n is 3.

6. The glass depth filter of claim 1, wherein the glass depth filter has a pore size of about 1 μm.

7. A glass fiber depth filter, the glass fiber depth filter being functionalized by an amino functional siloxane, the amino functional siloxane corresponding to the general structure:
NR1R2-(CH₂)n-NR3-(CH₂)m-Si(O⁻)₃
wherein
R1, R2, and R3 independently represent hydrogen, alkyl, cycloalkyl, aralkyl, or aryl;
n is an integer of 1 to 15; and
m is an integer of 1 to 15.

8. The glass depth filter of claim 7, wherein R1, R2, and R3 independently represent H or alkyl.

9. The glass depth filter of claim 7, wherein R1, R2, and R3 independently represent H.

10. The glass depth filter of claim 7, wherein n is 6 and m is 3.

11. The glass depth filter of claim 7, wherein R1, R2, and R3 independently represent H, n is 6, and m is 3.

12. The glass depth filter of claim 7, wherein the glass depth filter has a pore size of about 1 μm.

13. A method for preparing a glass fiber depth filter functionalized by an amino functional siloxane, the method comprising:
(1) providing a glass fiber depth filter;
(2) in an acidic solution comprising water and a miscible organic solvent, contacting the glass fiber depth filter with an amino functional silane corresponding to one of the general structures:
Cl⁻N⁺R1R2R3-(CH₂)n-Si(X)₃
or
NR1R2-(CH₂)n-NR3-(CH₂)m-Si(X)₃
wherein
R1, R2, and R3 independently represent hydrogen, alkyl, cycloalkyl, aralkyl, or aryl;
n is an integer of 1 to 15;
m is an integer of 1 to 15; and
X represents alkoxy, acyloxy, halogen, or amine.

14. The method of claim 13, wherein R1, R2, and R3 independently represent alkyl or H.

15. The method of claim 13, wherein X represents alkoxy.

16. The method of claim 13, wherein the amino functional silane comprises N-trimethoxysilylpropyl-N,N,N-trimethylammonium chloride.

17. The method of claim 13, wherein the amino functional silane comprises N-(6-aminohexyl)aminopropyltrimethoxysilane.
